(19) United States
(12) Patent Application Publication
(10) Pub. No.: US 2025/0012406 A1
(43) Pub. Date: Jan. 9, 2025

(54) SYSTEM FOR SUPPLYING A CONSUMER DESIGNED TO BE SUPPLIED WITH A FUEL PREPARED FROM A GAS GENERATED BY THE EVAPORATION OF A CRYOGENIC LIQUID COMPRISING AT LEAST METHANE

(71) Applicant: GAZTRANSPORT ET TECHNIGAZ, Saint Remy Les Chevreuse (FR)

(72) Inventors: Bernard AOUN, Saint Remy Les Chevreuse (FR); Pavel BORISEVICH, Saint Remy Les Chevreuse (FR)

(73) Assignee: GAZTRANSPORT ET TECHNIGAZ, Saint Remy Les Chevreuse (FR)

(21) Appl. No.: 18/709,839

(22) PCT Filed: Nov. 3, 2022
(86) PCT No.: PCT/FR2022/052074

§ 371 Date: May 14, 2024

(30) Foreign Application Priority Data
Nov. 26, 2021 (FR) 2112613

(51) Int. Cl. F17C 9/04

(52) U.S. Cl. CPC F17C 9/04; F17C 2205/0338; F17C 2221/033; F17C 2223/0161; F17C 2227/0157; F17C 2227/0339; F17C 2270/0105

(57) ABSTRACT

A supply system for supplying a fuel prepared from a gas generated by the evaporation of a cryogenic liquid stored in a tank includes a fuel preparation system. The preparation system includes a phase separator and a compression member arranged between a liquid outlet of the phase separator and the tank, and the supply system includes a calibrated opening arranged between the compression member and the tank on a pipe which opens into the tank.

The present invention relates to the field of the transport and/or storage of a cryogenic liquid. The invention relates more particularly to a system for supplying a consumer that is designed to be supplied with a fuel prepared from a cryogenic liquid comprising at least methane.

Gaseous hydrocarbons at ambient temperature and atmospheric pressure are liquefied at cryogenic temperatures, that is, temperatures below −60° C., in order to facilitate their transport and/or storage. The hydrocarbons thus liquefied, also called cryogenic liquids, are then placed in tanks of a structure, particularly a floating structure.

However, such tanks are never perfectly thermally insulated so that natural evaporation of the cryogenic liquid is inevitable. The phenomenon of natural evaporation is called boil-off, and the gas generated by this natural evaporation is called boil-off gas (BOG). The tanks of the structure thus comprise both the cryogenic liquid in liquid form and the gas generated by the boil-off of this cryogenic liquid.

Part of the gas generated by the boil-off of the cryogenic liquid may be used as fuel to supply at least one consumer, such as an engine, provided to meet the operational energy needs of the floating structure. Thus, it is possible to generate electricity for electrical equipment of this structure.

To that end, there are supply systems designed to be supplied with a fuel prepared from a gas generated by the evaporation of different cryogenic liquids comprising methane stored and/or transported, at the same time or alternately, in at least one tank of a structure. The particular type of cryogenic liquid transported and/or stored in the structure's tanks and the gas generated by natural evaporation are then both suitable for supplying the consumer. Such systems generally feature two phase separators complemented with compression members. A first separator can thus be dedicated to delivering to the consumer the methane-rich gas generated by the evaporation of the cryogenic liquid, at a pressure adapted to the consumer. A second separator can be dedicated to returning the cryogenic liquid to the tank, also at a suitable pressure.

However, the use of a plurality of separators increases costs, since the second separator is associated with various components such as valves, sensors and piping, the multiplication of which generates considerable expense and integration difficulties.

The aim of the present invention is to overcome these drawbacks by proposing a consumer supply system that omits the second separator, with pressure management on return to the tank being provided, at least in part, by a calibrated opening. Such a supply system is therefore easier to implement and less costly.

The main object of the present invention is a consumer supply system designed to be supplied with a fuel prepared from a gas generated by the evaporation of a cryogenic liquid comprising at least methane, this cryogenic liquid being stored in at least one tank, the supply system comprising at least one compression device, a heat exchanger, a supply branch designed to bring at least a portion of the gas from the tank to the consumer and a cooling branch designed to cool the gas taken from the tank, the heat exchanger comprising a first pass arranged on the supply branch and a second pass arranged on the cooling branch, the second pass being designed to exchange calories with the first pass in order to at least partially liquefy the gas circulating in the first pass, the supply system comprising a fuel preparation system arranged between the heat exchanger and the consumer. According to the invention, the preparation system comprises a phase separator and at least one compression member arranged between a liquid outlet of the phase separator and the tank, at least one gas outlet of the phase separator being connected to the consumer to deliver the fuel to it, and the supply system comprises at least one calibrated opening arranged between the compression member and the tank on a pipe which opens into the tank.

The supply system according to the invention is designed to supply fuel to the consumer, which may for example be an engine of a structure, in particular a floating structure, which this supply system is intended to equip. To this end, the supply system makes it possible to compress the gas generated by the evaporation of the cryogenic liquid comprising at least methane, and to liquefy it at least in part by heat exchange within the heat exchanger. The phase separator makes it possible to separate a liquid phase from a gaseous phase, the gaseous phase corresponding to the fuel for the consumer. This gaseous phase of the at least partly liquefied gas has a different composition from the cryogenic liquid contained in the tank; more precisely, the gaseous phase of the at least partly liquefied gas has a methane content higher than the methane content of the cryogenic liquid. Preferentially, the gaseous phase of the at least partly liquefied gas has a methane index greater than or equal to 70.

Advantageously, the supply system comprises a single-phase separator. Such a supply system configuration makes it possible to reduce installation difficulties and the cost of an additional phase separator.

The fuel preparation system is connected on the intake side to the supply branch, and on the output side either to the cooling branch or directly to the tank, separate from the cooling branch. These two possibilities correspond to two distinct modes of implementation, which will be described in greater detail below.

The pipe intended to open into the tank comprises a tube and all the elements arranged on this tube, in particular the calibrated opening and the compression member.

According to one feature of the invention, the calibrated opening is located closer to the end of the pipe which opens into the tank than to the compression member.

In particular, the calibrated opening is located at the end of the pipe opening into the tank.

Even more particularly, the end of the pipe opening into the tank is at a height of less than 20% of the total tank height, measured from the tank bottom wall.

According to another feature of the invention, the cryogenic liquid is a liquefied natural gas or a mixture of liquid methane and an alkane having at least two carbon atoms.

Preferentially, this mixture consists of liquid ethane and liquid methane. More generally, the alkane having at least two carbon atoms is chosen from ethane, propane, butane and at least one mixture thereof. “Butane” here can refer to n-butane and isobutane, also known as 2-methylpropane.

According to one feature of the invention, a direction of flow of the cryogenic liquid in the first pass of the heat exchanger is oriented in the same direction as a direction of flow of the cryogenic liquid in the second pass of the heat exchanger.

Alternatively, a direction of flow of cryogenic liquid in the first pass of the thermal heat exchanger is oriented in an opposite direction to a direction of flow of cryogenic liquid comprising methane in the second pass of the thermal heat exchanger.

In other words, depending on different embodiments, the flow of the cryogenic liquid comprising methane in the first pass of the heat exchanger takes place either co-current or counter-current of the cryogenic liquid comprising methane in the second pass of the thermal heat exchanger.

According to another feature of the invention, the preparation system is connected at the intake side to an output of the first pass and at the output side to an output of the second pass.

According to one feature, the compression device is arranged on the supply branch between the tank and the heat exchanger.

The cryogenic liquid can thus be compressed before passing into the heat exchanger.

According to one feature of the invention, the supply branch comprises a heat exchanger designed to exchange calories between, on the one hand, the gas generated by the evaporation of the cryogenic liquid prior to its compression by the compression device, and on the other hand this gas compressed by the compression device.

A heat exchanger of this type can be positioned between the tank and the compression device. It comprises a first passage arranged between a tank outlet and a compression device intake, and a second passage arranged between the compression device outlet and an intake of the first heat exchanger pass. A flow of cryogenic liquid comprising methane in the first pass of the heat exchanger is oriented in a direction opposite a flow of cryogenic liquid comprising methane in the second pass of the heat exchanger. In other words, the flow of the cryogenic liquid comprising methane in the first pass of the heat exchanger takes place against the flow of the cryogenic liquid comprising methane in the second pass of the heat exchanger.

In one embodiment of the invention, the liquid outlet of the phase separator is connected to the cooling branch, with the pipe forming part of the cooling branch.

According to one feature, the compression member is arranged between the liquid outlet of the phase separator and the cooling branch.

In this configuration, the phase separator and compression member are connected to the cooling branch. The pipe on which the calibrated opening is located is then integrated into this cooling branch.

In another embodiment, the liquid outlet of the phase separator is connected to the tank directly via the pipe.

In this alternative design, the phase separator is no longer connected to the cooling branch but is connected directly to the tank via the pipe, on which the compression member is located.

According to one feature of the invention, the cooling branch comprises a device for cooling the gas taken from the tank, the cooling device being arranged between said tank and an intake of the second pass of the heat exchanger.

This cooling device makes it possible to improve the exchange of calories between the first pass of the thermal heat exchanger and the second pass of the heat exchanger. This type of cooling device enables the temperature of the second pass to be lowered even further, for example by using a nitrogen thermodynamic cycle.

The invention further relates to a floating structure intended for the transport and/or storage of cryogenic liquid, comprising at least one tank that contains the cryogenic liquid, at least one consumer that consumes a fuel prepared from a gas generated by the evaporation of the cryogenic liquid and at least one supply system as previously described, the supply system comprising at least one duct connecting the gas outlet of the first phase separator to the consumer.

According to one feature, the floating structure comprises a first tank and a second tank, the preparation system comprising a first pressure regulator arranged between the compression member and the first tank and a second pressure regulator arranged between the compression member and the second tank, the compression member, the first pressure regulator and the second pressure regulator being fluidically connected by a connection point, a first calibrated opening being arranged in a first line between the first pressure regulator and the first tank and a second calibrated opening being arranged in a second line between the second pressure regulator and the second tank.

Each of the first and second tanks can be used to supply fuel to a different consumer. The supply system for one of these consumers can also draw cryogenic liquid from the first tank but discharge an unused portion of this cryogenic liquid into the second tank. An outlet from the first pass and an outlet from the second pass of the heat exchanger are each connected to the connection point.

The invention further relates to a method for preparing a fuel from a gas generated by the evaporation of a cryogenic liquid stored in at least one tank by a supply system as previously described, the method comprising a step of compressing the gas by the compression device, a step of exchanging calories in the thermal heat exchanger between the compressed gas and the cooled cryogenic liquid in order to at least partially liquefy the compressed gas, a step of separating a liquid phase and a gaseous phase of the gas within the phase separator and a step of supplying said gaseous phase as fuel to a consumer.

Other features, details and advantages of the invention will appear more clearly upon reading the following description on the one hand, and from exemplary embodiments given for illustrative purposes and without limitation with reference to the appended drawings on the other hand, wherein:

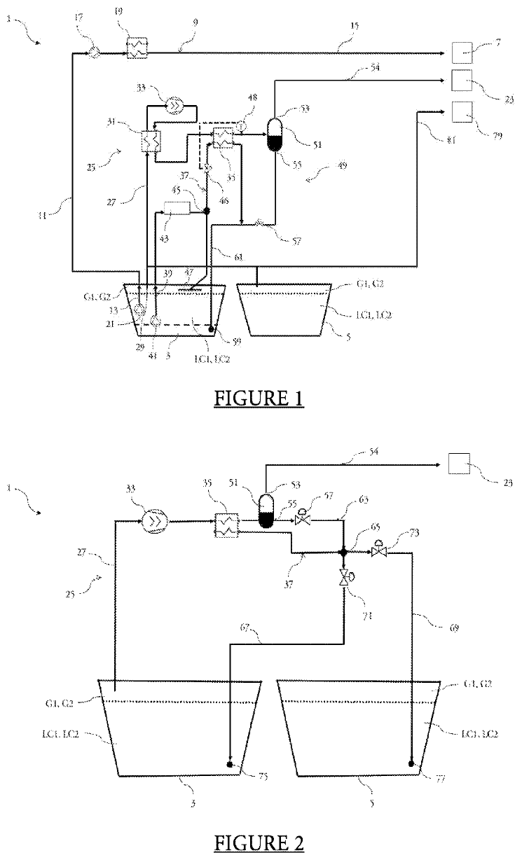

FIG. 1 schematically shows a floating structure comprising a supply system according to the invention, according to a first embodiment;

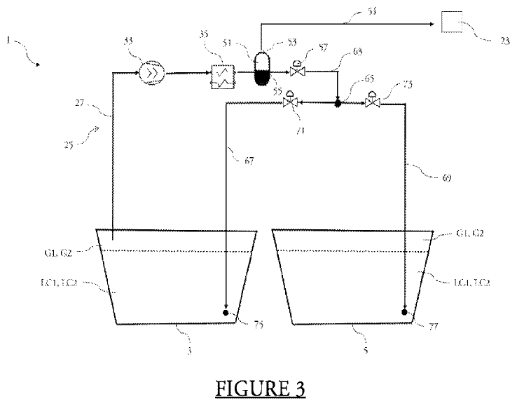

FIG. 2 schematically shows part of the supply system shown in FIG. 1 according to a second embodiment;

FIG. 3 schematically shows the part of the supply system shown in FIG. 2 according to a third particular embodiment.

The features, variants, and the different embodiments of the invention can be combined with one another in various combinations as long as they are not incompatible or exclusive of one another. It is possible, in particular, to imagine variants of the invention that comprise only a selection of the features that are described below in isolation from the other features that are described, provided that this selection of features is sufficient to confer a technical advantage and/or to differentiate the invention from the prior art.

In the figures, the members common to several figures retain the same reference.

FIG. 1 schematically shows a floating structure 1 according to the invention. The floating structure 1 comprises two tanks 3, 5, including a first tank 3 and a second tank 5. These tanks 3, 5 are suitable for storing and/or transporting at least one cryogenic liquid LC1, LC2 comprising methane. Such a cryogenic liquid LC1, LC2 can be liquefied natural gas LC1 or a mixture LC2 of methane and an alkane having at least two carbon atoms. The alkane may be chosen from ethane, propane, butane and at least one mixture thereof. Preferentially, the mixture consists of ethane and methane. The mixture LC2 has a methane index of less than 70.

Since the thermal insulation of the tanks 3, 5 is not perfect, part of the cryogenic liquid LC1, LC2 boils off. Consequently, the tanks 3, 5 of the structure 70 comprise both the cryogenic liquid LC1, LC2 and a gas G1, G2 generated by the evaporation of this cryogenic liquid LC1, LC2, a separation between this cryogenic liquid LC1, LC2 and this gas G1, G2 within the tanks 3, 5 being shown in the figures by dotted lines.

The floating structure 1 comprises at least one propulsion device 7 supplied with a fuel. As an example, the at least one propulsion device 7 may be a propulsion engine of the structure, such as an ME-GI or XDF engine. It is understood that this is only an exemplary embodiment of the present invention, and that provision may be made for the installation of different propulsion devices without departing from the context of the present invention.

The floating structure 1 comprises a fuel supply system 9 for the propulsion unit 7, which includes a branch 11 for withdrawing the cryogenic liquid LC1, LC2 contained in the first tank 3 of the floating structure 1.

A liquid intake 13 of the withdrawal branch 11 is immersed in the cryogenic liquid LC1, LC2 so that it can be withdrawn, while a gas outlet 15 of the withdrawal branch 11 is connected to the propulsion unit 7 to supply it with fuel.

The withdrawal branch 11 can include at least one pump 17 for supplying fuel to propulsion unit 7 at a suitable pressure, and an evaporator-superheater 19 for heating the fuel to a suitable temperature. The fuel is in gaseous or supercritical form at the gas outlet 15 of the withdrawal branch 11.

The withdrawal branch 11 may comprise at least one withdrawal pump 21 so as to control the withdrawal of the cryogenic liquid LC1, LC2 contained in the first tank 3. In other words, said withdrawal pump 21 makes it possible to authorize the withdrawal, to prohibit the withdrawal and/or to regulate the withdrawal flow rate of the cryogenic liquid LC1, LC2. To that end, the withdrawal valve 21 is arranged between the liquid intake 13 of the withdrawal branch 11 and an intake of the heater-evaporator 19.

In addition to the propulsion unit 7, the floating structure 1 comprises at least one consumer 23 of a fuel prepared from a gas G1, G2 contained in the tanks 3, 5 of the floating structure 1, this gas G1, G2 being generated by the natural evaporation of the cryogenic liquid LC1, LC2 stored and/or transported in these tanks 3, 5. The consumer 23 may be an electric generator of the DFDE (Dual Fuel Diesel Electric) type, that is to say, a gas consumer designed to ensure the electrical supply of the floating structure 1. It is understood that this is only an example embodiment of the present invention and that provision may be made for the installation of different gas consumers without departing from the context of the present invention.

The floating structure 1 comprises a supply system 25 for supplying fuel to the consumer 23, shown in FIG. 1 in a first embodiment. In particular, the supply system 25 comprises a supply branch 27 which fluidically connects the first tank 3 to the consumer 23, that is, it is designed to supply at least a portion of the gas G1, G2 from this first tank 3 to the consumer 23. The supply branch comprises a gas intake 29, which is arranged in the first tank 3 so as to be within the gas G1, G2 to be withdrawn. This gas intake 29 is connected to a heat exchanger 31 by at least one pipe, this heat exchanger 31 being arranged between the first tank 3 and a compression device 33 also belonging to the supply branch 27. The heat exchanger 31 comprises a first passage arranged between the gas intake 29 of the first tank 3 and an intake of the compression device 33, and a second passage arranged between an outlet of this compression device 33 and a heat exchanger 35, the operation of which will be described in more detail later. The heat exchanger 31 is designed to exchange calories between, on the one hand, the gas G1, G2 generated by the evaporation of cryogenic liquid LC1, LC2 prior to its compression by the compression device 33 and, on the other hand this gas G1, G2 once it has been compressed by compression device 33. It is understood that the first passage through which the gas G1, G2 flows at the outlet of the first tank 3 makes it possible to cool the second passage through which the gas G1, G2 flows after compression. In this way, the flow of gases G1, G2 in the first passageway is countercurrent to the flow of gases G1, G2 in the second passage.

As already mentioned, an outlet of the compression device 33 is connected to the heat exchanger 35. In this way, the gas G1, G2 generated by the natural evaporation of the cryogenic liquid LC1, LC2 can be compressed prior to its passage into this heat exchanger 35. The heat exchanger 35 has a first pass, arranged on the supply branch 27, and a second pass arranged on a cooling branch 37. This cooling branch 37 will now be described in more detail.

The cooling branch 37 is designed to participate in the cooling of the gas G1, G2 generated by the evaporation of the cryogenic liquid LC1, LC2, so that this gas G1, G2 is liquefied and returns to a liquid state. Such liquefaction takes place within heat exchanger 35, whose second pass corresponds to a portion of the cooling branch 37. This second pass is supplied with cryogenic liquid LC1, LC2 taken from the first tank 3. For this purpose, the cooling branch 37 has a liquid intake 39 arranged in the first tank 3, this liquid intake 39 being immersed in the cryogenic liquid LC1, LC2. Like the withdrawal branch 11, this liquid intake 39 may feature at least one withdrawal control pump 41 similar to withdrawal pump 21, so as to control the withdrawal of cryogenic liquid LC1, LC2 contained in the first tank 3. This withdrawal control pump 41 can therefore authorize withdrawal, prohibit withdrawal and/or regulate the rate at which the cryogenic liquid LC1, LC2 is withdrawn by the cooling branch 37. In a variant not shown here, the withdrawal pump 21 and the withdrawal control pump 41 can be combined.

The liquid intake 39 is fluidically connected to a cooling device 43, which is therefore arranged between this liquid intake 39 and the heat exchanger 35. This cooling device 43 helps lower the temperature of the cryogenic liquid LC1, LC2 flowing within the cooling branch 37. Such a cooling device 43 may involve a nitrogen thermodynamic cycle, which makes it possible to cool the cryogenic liquid LC1, LC2 before it enters the second pass of the heat exchanger 35. Between the cooling device 43 and the heat exchanger 35, the cooling branch 37 may have a diversion point 45. At this diversion point 45, the cryogenic liquid LC1, LC2 cooled by the cooling device 43 can alternatively be supplied to the heat exchanger 35 or returned to the first tank 3, such diversion being controllable by a valve not shown here. When this cryogenic liquid LC1, LC2 is returned to the first tank 3, it can participate in the operation of a spray bar 47, which cools the gas G1, G2 contained in this first tank 3 and thus reduces the pressure within the first tank 3. Conversely, when the cooled cryogenic liquid LC1, LC2 is sent to heat exchanger 35 and flows in the second pass, it can exchange calories with the gas G1, G2 flowing circulating in the first pass and thus liquefy it at least in part. A direction of flow of the gas G1, G2 in the first pass of the heat exchanger 35 is oriented in the same direction as a direction of flow of the cryogenic liquid LC1, LC2 in the second pass of the heat exchanger 35; in other words, the flow in the first and second passes of the heat exchanger 35 is co-current. Although not shown, the direction of flow of the gas G1, G2 in the first pass of the heat exchanger 35 could alternatively be oriented in a direction opposite to the direction of flow of the cryogenic liquid LC1, LC2 in the second pass of this heat exchanger 35, that is, countercurrent. Between the diversion point 45 and the second pass of the heat exchanger 35, the cooling branch can be equipped with a valve 46 whose operation is conditioned by the control of a temperature sensor 48 located at the outlet of the first pass of the heat exchanger 35.

An outlet from the first pass of the heat exchanger 35 is fluidically connected to a preparation system 49, at least a portion of which forms the supply branch 27. It is understood that the preparation system 49 is therefore at least partly located between the heat exchanger 35 and the consumer 23. According to the invention, this preparation system 49 comprises a single-phase separator 51. This phase separator 51 enables a gaseous phase to be separated from a liquid phase of the cryogenic liquid LC1, LC2 within the supply system 25, this gaseous phase being the gas G1, G2. Such a gaseous phase thus corresponds to the fuel intended for the consumer 23. The phase separator 51 thus comprises a gas outlet 53 through which the gas G1, G2 leaves the phase separator 51 to supply the consumer 23 via at least one pipe 54, and a liquid outlet 55 through which the cryogenic liquid LC1, LC2 can be returned to the cooling branch 37 or directly to either the first tank 3 or the second tank 5. Particular applications involving this second tank 5 will be described below in relation to FIGS. 2 and 3. The preparation system 49 further comprises at least one compression member 57, which is arranged between the liquid outlet 55 of the phase separator 51 and either the cooling branch 37 or the tanks 3, 5.

On the floating structure 1 shown in FIG. 1, the preparation system 49 is connected at the outlet to the cooling branch 37, and the compression member 57 is located between the phase separator 51 and this cooling branch 37. Here, the supply system 25 comprises a calibrated opening 59 arranged between this compression member 57 and the first tank 3, on a pipe 61 which opens into this first tank 3. Such a calibrated opening 59 enables the pressure of the cryogenic liquid LC1, LC2 returning to the first tank 3 to be controlled; for this purpose, it may, for example, be located at the end of the pipe 61. It is understood that the pipe 61 on which the calibrated opening 59 is arranged is integrated into the cooling branch 37.

More precisely, the end of the pipe 61 where the calibrated opening 57 is located can be arranged at a height of less than 20% of a total height of the first tank 3, measured from a bottom wall of this first tank 3. Such a height is shown in FIG. 1 by a dashed line.

FIGS. 2 and 3 show in simplified form particular embodiments of a part of the floating structure 1, with a second embodiment shown in FIG. 2 and a third embodiment shown in FIG. 3.

In the floating structure 1 shown in FIG. 2, the compression member 57 is connected to the first pass of the heat exchanger 35. It is arranged on a pipe 63 which joins the cooling branch 37, which comprises the second pass of this heat exchanger 35, at a connection point 65. The first-pass outlet and a second-pass outlet of the heat exchanger 35 are therefore both connected to the connection point 65. This connection point 65 also enables the connection of two pipes 67, 69, each of which is connected to one of the tanks 3, 5, with a first pipe 67 opening into the first tank 3 and a second pipe 69 opening into the second tank 5. The first pipe 67 carries a first pressure regulator 71, while the second pipe 69 carries a second pressure regulator 73, which are thus fluidically connected by the connection point 65. According to the invention, a first calibrated opening 75 is arranged in the first pipe 67 between the first pressure regulator 71 and the first tank 3, and a second calibrated opening 77 is arranged in the second pipe 69 between the second pressure regulator 73 and the second tank 5. In this way, the supply system 25 can withdraw the gas G1, G2 from the first tank 3 and discharge the cryogenic liquid LC1, LC2 not used to supply the consumer 23 from both the first tank 3 and the second tank 5. In the same way as for the floating structure shown in FIG. 1, in the second embodiment the first and second pipes 67, 69 having the first and second calibrated openings are integrated into the cooling branch 37. By way of examples of this second embodiment, for a flow rate of 3.5 m³/h of cryogenic liquid LC1, LC2 returned to one of the tanks 3, 5 and with a calibrated opening 75, 77 having a diameter of 7.5 millimeters, the pressure reduction will be 2.2 bars. For a flow rate of 2.3 m³/h and a calibrated opening 75, 77 having a diameter of 6.5 millimeters, the pressure reduction will be 1.9 bar, and for a flow rate of 1.15 m³/h with a calibrated opening 75, 77 having a diameter of 4.9 millimeters, it will be 2.1 bars.

FIG. 3 shows the third embodiment, wherein the compression member 57 is not connected to the cooling branch 37 but directly to the tanks 3, 5 via the first pipe 67 or the second pipe 69. The compression member 57 is thus located between the second pass of the heat exchanger 35 and the connection point 65, which here connects the first pipe 67 and the second pipe 69. As in the second embodiment, the first calibrated opening 75 is located in the first pipe 67 between the first pressure regulator 71 and the first tank 3, and the second calibrated opening 77 is located in the second pipe 69 between the second pressure regulator 73 and the second tank 5. As examples of this third embodiment, for a flow rate of 30 m³/h of cryogenic liquid LC1, LC2 sent to one of the tanks 3, 5 and with a calibrated opening 75, 77 having a diameter of 13 millimeters, the pressure reduction will be 2.1 bar. For a flow rate of 20 m³/h and a calibrated opening 75, 77 with a diameter of 11.5 millimeters, the pressure reduction will be 2.2 bars, and for a flow rate of 10 m³/h with a calibrated opening 75, 77 with a diameter of 8.5 millimeters, it will be 2.3 bars.

Whether in the first, second or third embodiment, the supply system 25 may comprise a conversion device, not shown here, designed to alternate between a first configuration wherein the fuel supplied to the consumer 23 is prepared from the gas G1 generated by the evaporation of the liquefied natural gas LC1, and a second configuration wherein this fuel is prepared from a gas G2 generated by the evaporation of the mixture LC2. The invention also relates to a method for preparing such a fuel. This method includes a step wherein the gas G1, G2 taken from the tank(s) 3, 5 is compressed by the compression device 33. This is followed by a heat exchange step in the heat exchanger 35 between the compressed gas G1, G2 and the cryogenic liquid LC1, LC2 cooled by the cooling branch 37, to at least partially liquefy this compressed gas G1, G2. The preparation process continues with a step of separating the liquid phase and the gaseous phase of the gas G1, G2 within the phase separator 51, and ends with a step of supplying said gaseous phase as a fuel to the consumer 23, this fuel using the pipe 54 for this purpose.

Moreover, the floating structure 1 can also include a control unit 79 for the consumer 23, as shown in FIG. 1. Such a control unit 79 can in particular perform regulation and control operations. For this purpose, it can be supplied by a supply system 81, through which the gas G1, G2 generated by the natural evaporation of the cryogenic liquid LC1, LC2 is taken from both the first tank 3 and the second tank 5.

The present invention thus proposes a system for supplying a consumer of a floating structure using a single-phase separator, with return pressure management in a tank of this floating structure being provided, at least in part, by a calibrated opening.

The present invention cannot, however, be limited to the means and configurations described and shown here, and it also extends to any equivalent means or configuration as well as to any combination technically using such means.

1. A supply system for a consumer designed to be supplied with a fuel prepared from a gas generated by the evaporation of a cryogenic liquid comprising at least methane, this cryogenic liquid being stored in at least one tank, the supply system comprising:
at least one compression device,
a heat exchanger,
a supply branch designed to supply at least a portion of the gas from the tank to the consumer and a cooling branch designed to cool the gas taken from the tank, the heat exchanger comprising a first pass arranged on the supply branch and a second pass arranged on the cooling branch, the second pass being designed to exchange calories with the first pass in order to at least partially liquefy the gas flowing in the first pass, the compression device being intended to be arranged on the supply branch between the tank and the heat exchanger,
a fuel preparation system arranged between the heat exchanger and the consumer,
wherein the preparation system comprises a phase separator and at least one compression member arranged between a liquid outlet of the phase separator and the tank, at least one gas outlet of the phase separator being intended to be connected to the consumer for delivery of the fuel, and
wherein the supply system comprises at least one calibrated opening intended to be arranged within the tank between the compression member and one end of a pipe intended to open into the tank.

2. The supply system according to claim 1, wherein the calibrated opening is arranged closer to the end of the pipe which opens into the tank than to the compression member.

3. The supply system according to claim 1, wherein the cryogenic liquid is a liquefied natural gas or a mixture of liquid methane and an alkane having at least two carbon atoms.

4. The supply system according to claim 1, wherein a flow direction of the cryogenic liquid in the first pass of the heat exchanger is oriented in the same or opposite direction to a flow direction of the cryogenic liquid in the second pass of the heat exchanger.

5. The supply system according to claim 1, wherein the preparation system is connected on the intake side to an output of the first pass and on the output side to an output of the second pass.

6. The supply system according to any one of the claim 1, wherein the supply branch comprises a heat exchanger designed to exchange calories between the gas generated by the evaporation of the cryogenic liquid prior to its compression by the compression device, and this gas compressed by the compression device.

7. The supply system according to claim 1, wherein the liquid outlet of the phase separator is connected to the cooling branch, the pipe forming part of the cooling branch.

8. The supply system according to claim 7, wherein the compression member is arranged between the liquid outlet of the phase separator and the cooling branch.

9. The supply system according to claim 1, wherein the liquid outlet of the phase separator is intended to be connected to the tank directly via the pipe.

10. The supply system according to claim 1, wherein the cooling branch comprises a device for cooling the gas taken from the tank, the cooling device being arranged between said tank and an intake of the second pass of the heat exchanger.

11. A floating structure intended for the transport and/or storage of cryogenic liquid comprising:
at least one tank that contains the cryogenic liquid,
at least one consumer that consumes a fuel prepared from a gas generated by the evaporation of the cryogenic liquid, and
at least one supply system according claim 1, the supply system comprising at least one duct connecting the gas outlet of the phase separator to the consumer.

12. The floating structure according to claim 11, comprising a first tank and a second tank, the preparation system comprising a first pressure regulator arranged between the compression member and the first tank and a second pressure regulator arranged between the compression member and the second tank, the compression member, the first pressure regulator and the second pressure regulator being fluidically connected via a connection point, a first calibrated opening being arranged in a first pipe between the first pressure regulator and the first tank, and a second calibrated opening being arranged in a second pipe between the second pressure regulator and the second tank.

13. A method for preparing a fuel from a gas generated by the evaporation of the cryogenic liquid stored in at least one tank by a supply system according to claim 1, the method comprising:
a step of compressing the gas by the compression device,
a step of exchanging calories in the heat exchanger between the compressed gas and the cooled cryogenic liquid in order to at least partially liquefy the compressed gas,
a step of separating a liquid phase and a gaseous phase of the gas in the phase separator, and
a step of supplying said gaseous phase as fuel to the consumer.
